(19) United States
(12) Patent Application Publication
(10) Pub. No.: US 2011/0246500 A1
(43) Pub. Date: Oct. 6, 2011

(54) STORING AND QUERYING OF USER FEEDBACK IN A PERSONAL REPOSITORY ACCESSIBLE TO A PERSONAL COMPUTING DEVICE

(76) Inventors: Praphul Chandra, Bangalore (IN); Ajay Gupta, Bangalore (IN)

(21) Appl. No.: 12/750,473

(22) Filed: Mar. 30, 2010

(51) Int. Cl. G06F 17/30; G06F 15/16

(52) U.S. Cl. 707/769; 707/E17.014; 707/784; 707/E17.005; 709/206

(57) ABSTRACT

Various example embodiments relate to a mechanism for writing feedback to a personal repository accessible to a personal computing device. The mechanism may receive a request for writing feedback of a user of the personal computing device regarding a particular item to the personal repository. The mechanism may also store the feedback of the user regarding the particular item in the personal repository. In addition, the mechanism may send a response to an incoming query from a personal computing device controlled by a peer of the user regarding the feedback of the user stored in the personal repository. In some embodiments, feedback contained in the response to the peer may be constrained by repository access permissions specified for the peer by the user of the personal computing device.

### BACKGROUND

A typical computer user generates a massive amount of content in interacting with applications and websites. Much of this content contains an expression of the user's feedback regarding some item, place, service, or other entity. For example, a user may submit a rating, review, or recommendation to a website, post an opinion on a blog, or spend a duration of time viewing a local or remote file. In the aggregate, this user-generated content contains a wealth of information regarding users and their preferences and opinions.

Seeing the value proposition in mining this information, many commercial websites collect user-generated content and perform analysis of the content in the pursuit of increased revenue. Some online retailers, for example, perform collaborative filtering on the purchases of customers in order to make targeted recommendations to other customers, thereby increasing the likelihood of a sale. Other websites aggregate user content to display statistics, averages, and other useful attributes of items described in the content.

In addition, users may desire to share their feedback with other individuals. For example, a user may write a movie review on a particular website, then desire to share that review with his or her friends and family. In general, however, after submission of content to a website, the user has little or no control over the information. In particular, the user-generated content generally remains under control of the website that collected the information, making it difficult for the user to control what information is available and who may access it.

In some existing solutions, a user may access information provided from a number of users to a central server that aggregates content from multiple sources. Again, in these solutions, the user typically lacks control over his or her information, raising potential security and privacy concerns, particularly when the central server maintains a copy of all user-generated content. Furthermore, such solutions require the implementation of a new infrastructure, including, for example, a server available to receive, process, and respond to requests. In addition, these solutions generally lack tight integration with social networking information and, as a result, the user is unable to specify to whom feedback is provided or from whom feedback data is obtained using preexisting social networking links.

### BRIEF DESCRIPTION OF THE DRAWINGS

In the accompanying drawings, like numerals refer to like components or blocks. The following detailed description references the drawings, wherein:

FIG. 1 is a block diagram of an example of a personal computing device including a machine-readable storage medium encoded with instructions for storing feedback and responding to feedback requests;

FIG. 2 is a block diagram of an example of a personal computing device encoded with instructions for storing feedback from one or more applications and responding to feedback requests from one or more peer computing devices;

FIG. 3A is a block diagram of a series of modules for translation of user feedback into a format suitable for inclusion in a graphical schema;

FIG. 3B is a block diagram of a series of modules for generating and posting a structured document containing user feedback;

FIG. 4 is a flowchart of an example of a method for storing feedback of a user regarding a particular item in a personal repository;

FIG. 5 is a flowchart of an example of a method for requesting and receiving feedback from social networking peers of a user of a personal computing device;

FIG. 6 is a flowchart of an example of a method for responding to an incoming query from a personal computing device controlled by a peer of a user; and

FIG. 7 is a schematic diagram of an example operation flow illustrating storage of feedback, sending a query for feedback, and responding to such a query.

### DETAILED DESCRIPTION

As detailed above, in existing solutions for storing user feedback, the user generally lacks control over his or her content. Furthermore, existing solutions generally require a central server that stores a copy of user-generated content and that receives and responds to requests. In addition, existing solutions lack social networking integration, such that users are unable to effectively specify who may access their information and from which users to obtain queried information.

As described below, various embodiments relate to personal computing devices and related storage media and methods that allow for user control over feedback, minimize or eliminate the need for a central server, and allow for effective integration of social networking information. In particular, in some embodiments, a personal computing device may store feedback of a user regarding a particular item in a personal repository accessible to the personal computing device. In addition, in responding to incoming queries, the personal computing device may determine the feedback to be included in the response based on access permissions granted to the peer by the user. Furthermore, in some embodiments, a personal computing device may obtain feedback from a group of peers by determining a location for each peer using social networking information. Additional embodiments and applications of such embodiments will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that contains or stores executable instructions or other data (e.g., a hard disk drive, flash memory, etc.).

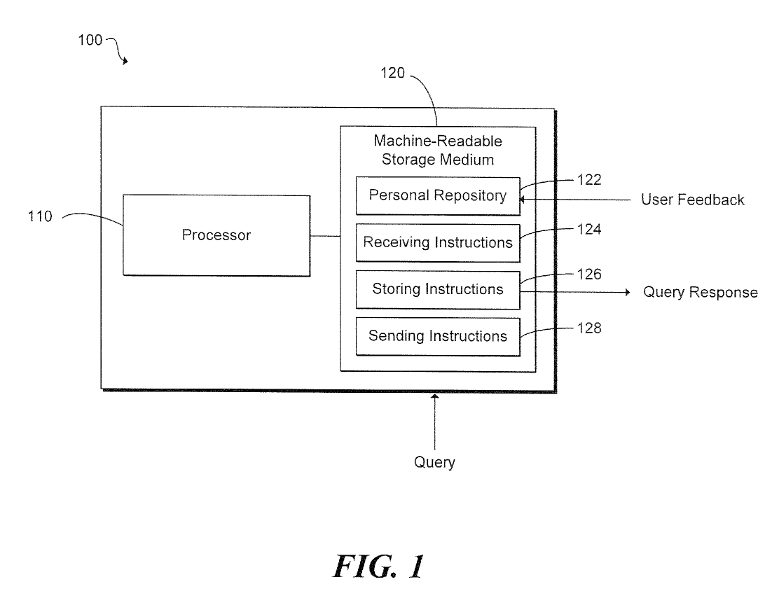

FIG. 1 is a block diagram of an example of a personal computing device 100 including a machine-readable storage medium 120 encoded with instructions for storing feedback and responding to feedback requests. Computing device 100 may be, for example, a desktop computer, a laptop computer, a handheld computing device, a mobile phone, or the like. In the embodiment of FIG. 1, computing device 100 includes a processor 110 and a machine-readable storage medium 120.

Processor 110 may be a central processing unit (CPU), a semiconductor-based microprocessor, or any other hardware device suitable for retrieval and execution of instructions stored in machine-readable storage medium 120. In particular, processor 110 may fetch, decode, and execute instructions 124, 126, 128 in order to write to and read from personal repository 122. Instructions 124, 126, 128 may constitute a portion of a web-based or local application or be a part of the operating system of computing device 100. Other suitable locations of the instructions will be apparent to those of skill in the art.

Personal repository 122 may be a machine-readable storage medium that stores feedback for a particular user. Thus, in some embodiments, personal repository 122 is an internal or external storage device (e.g., a hard disk, flash memory drive, etc.) coupled directly to computing device 100. Alternatively, personal repository 122 may be a portion of a storage device located on a remote server that may be accessed by computing device 100, such as a cloud server that maintains storage for the user. Although illustrated as encoded on the same machine-readable storage medium 120 as instructions 124, 126, 128, in some embodiments, personal repository 122 may be located on a distinct storage medium.

In some embodiments, the user may specify access permissions for peers that desire to access the feedback contained in personal repository 122. The user may control access based on categories of feedback including, for example, the type of feedback provided (e.g., star ratings, click data, etc.), the items to which the feedback relates (e.g., do not share reviews of prescription medications or doctors), or other criteria. Furthermore, the user may apply different access controls to different peers. For example, the user may manually define access levels for each peer in his or her social network, automatically define access levels based on the nature of the relationship (e.g., family, best friends, colleagues, etc.), or apply the same access controls to all peers. In this manner, the user may maintain control of access to his or her feedback, such that the user's information is only shared with the peers that are granted access.

Receiving instructions 124 may receive a request for writing feedback of a user of personal computing device 100 to personal repository 122. As illustrated, user feedback is shown as originating from a source external to computing device 100, such as a website or web-based application. In such instances, the user feedback may be received via a hardware network interface included in computing device 100. It should be noted, however, that user feedback may also originate from within computing device. For example, receiving instructions 124 may obtain feedback from an application in which a user assigns a rating to a media file. As another example, computing device 100 may obtain the feedback from the operating system or an application based on observation of a user's clicking patterns, frequency of opening particular files, etc.

Each instance of user feedback may relate to a particular item. Feedback may include any text, audio, or any other user input that indicates a user's disposition toward the particular item. Thus, the term “feedback” should be understood to include ratings, tags, user recommendations, text reviews, comments, opinions, blog postings, user attention to particular files or programs, and the like. Items include any entities, real-world or abstract, for which a user desires to provide feedback. Thus, to name a few examples, an item may be a book or audiobook, a movie, a music album, a news or opinion article, a product available for purchase, a hotel, a tourist destination, or a post by another user. Other suitable types of feedback and items for which feedback is provided will be apparent to those of skill in the art.

After receipt of the feedback to be written, storing instructions 126 may then write the feedback provided by the user to personal repository 122. In embodiments in which personal repository 122 is directly coupled to computing device 100, storing instructions 126 may write to personal repository 122 through a hardware bus. Alternatively, when personal repository 122 is located on a remote server, such as a cloud server, storing instructions 126 may write to personal repository using a wired or wireless network interface and an appropriate communications protocol, such as TCP/IP.

Sending instructions 128 may periodically receive a query from a peer personal computing device, then prepare a response to be sent to the peer. In particular, upon receipt of a query from a peer, sending instructions may first determine the feedback requested by the peer and identify the peer. Sending instructions 128 may then retrieve the desired feedback from personal repository 122, subject to the access permissions specified by the user for the particular peer. In some embodiments, personal repository 122 may be configured to receive a request from sending instructions 128, then return only the information permitted by the access permissions. Alternatively, sending instructions 128 may enforce the access permissions, such that sending instructions only request information for which the user has granted access to the peer.

Regardless of the implementation, after retrieval of the feedback from personal repository 122, sending instructions 128 may then send a response to the query to the personal computing device controlled by the peer. For example, sending instructions 128 may transmit the response using a wired or wireless network interface and an appropriate communications protocol.

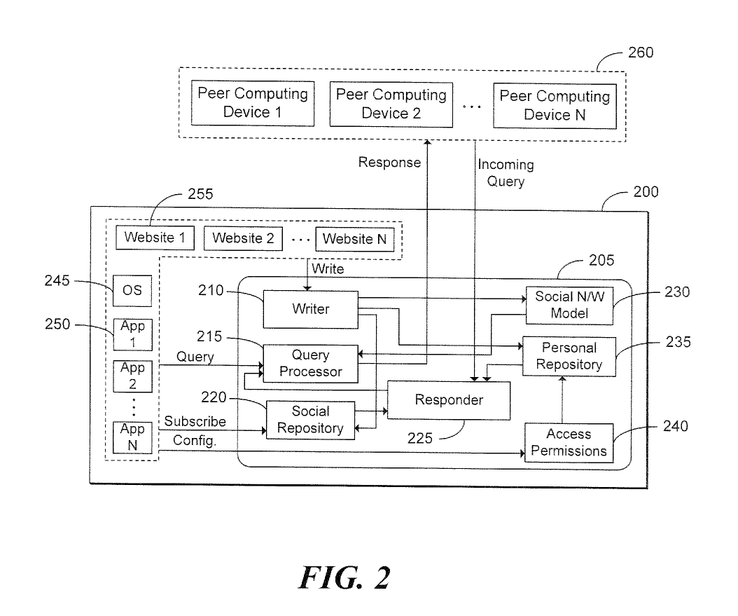

FIG. 2 is a block diagram of an example of a personal computing device 200 encoded with instructions for storing feedback from one or more applications and responding to feedback requests from one or more peer computing devices 260. Computing device 200 and peer computing devices 260 may each be, for example, a desktop computer, a laptop computer, a handheld computing device, a mobile phone, or the like. As with computing device 100, each computing device of FIG. 2 may include a processor and a machine-readable storage medium encoded with executable instructions.

Computing device 200 may include a feedback framework 205, which may comprise a number of components used to implement the feedback storing, reading, and responding processes described in detail herein. As described in further detail below, each component of framework 205 may comprise data storage, executable instructions for accessing that data, or a combination thereof.

Framework 205 may include a number of components used to implement an Application Programming Interface (API) 205. The API may comprise executable instructions that provide an externally-accessible interface for interaction with the components of framework 205. More specifically, the API may be accessible to local applications and services running on computing device 200 and may include interfaces provided by writer 210, query processor 215, and responder 225.

Writer 210 may provide an interface that enables applications, such as OS 245, local applications 250, and websites 255, to write data to social repository 220, social network model 230, and personal repository 235. In some embodiments, writer 210 may first receive a write request that identifies a data type (e.g., feedback or social information) and contains data corresponding to that data type. Upon receipt of the request from an application 245, 250, 255, writer 210 may determine the location of the corresponding storage module, then write the data to that storage module.

For example, when the write request relates to social networking information, writer 210 may determine the location of social networking model 230, then write the included data to the determined locations. The data in a write request to social networking model 230 may include, for example, a name of a person and a nature of the user's relationship with that person. In addition, a write request to social networking model 230 may include any information used to communicate with one or more peer computing devices 260 corresponding to that person (e.g., an email address, Internet Protocol or MAC address, instant messaging handle, etc.). Social networking model 230 may therefore contain all existing social relationships submitted by the user or an application and, in addition, represent the data used to submit queries or otherwise communicate with the identified peer computing devices 260.

When the write request relates to feedback regarding a particular item, writer 210 may determine the location of personal repository 235, then write the included data to the repository 235. In such cases, the data in the write request may include, for example, an identification of the application or service that created the feedback, an identification of the item, the feedback data for the item, and a context (e.g., location, time, etc.) of the feedback.

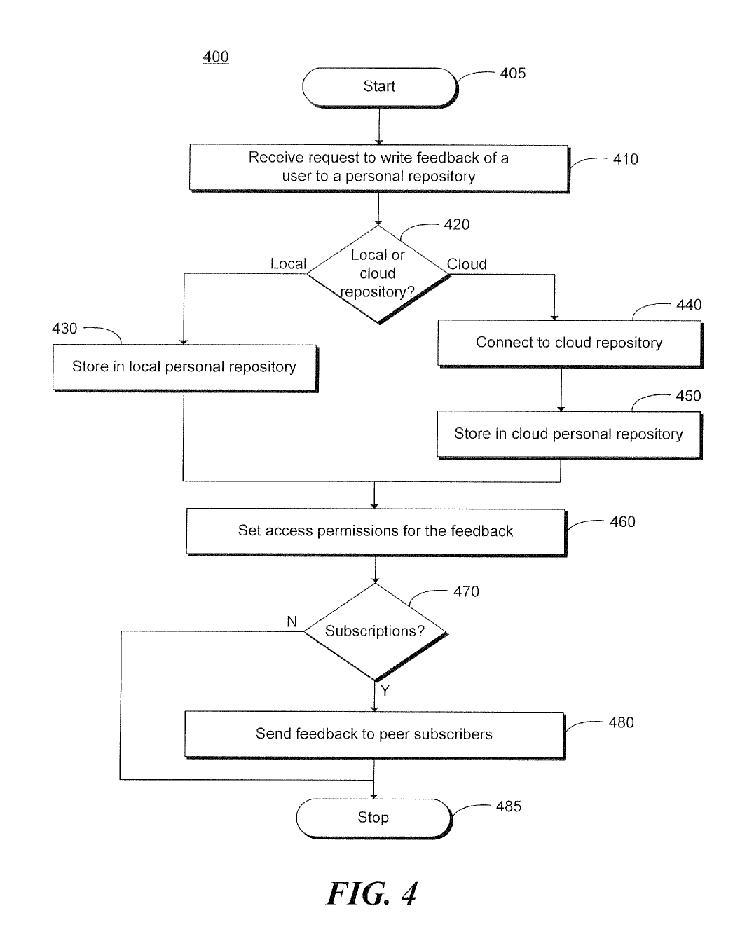

In some embodiments, writer 210 may write a duplicate of the feedback provided by the user to the particular application. In such cases, personal repository 235 will contain a copy of the data maintained by the application (e.g., data of a review that is also stored on a web server). Alternatively, writer 210 may only write a location of the feedback provided by the user, such that personal repository 235 may subsequently retrieve the feedback from the corresponding location as necessary. For example, when the data is also stored on a web server, writer 210 may simply write a Uniform Resource Locator (URL) from which the feedback may be retrieved. Further details of an embodiment for writing feedback to a personal repository are described in detail below in connection with FIG. 4.

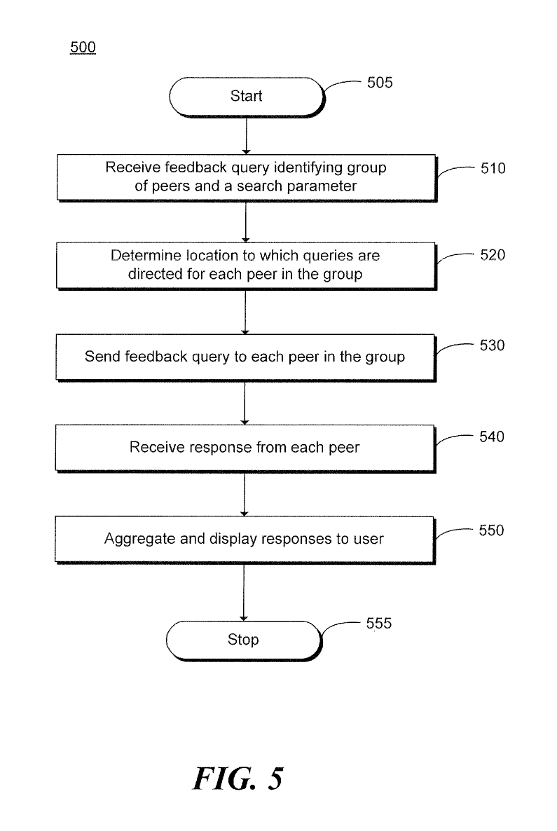

Query processor 215 may provide an interface that enables applications to submit queries and that sends query responses to peer computing devices 260. In order to submit queries to peers, query processor 215 may receive a query from the user of computing device 200, the query indicating a request for feedback from one or more peers 260. Query processor 215 may first determine the group of one or more peers identified in the query and an included search parameter. Query processor 215 may then access social networking model 230 to determine the location to which queries should be directed for each peer included in the group (e.g., an IP or MAC address, an email address, an IM handle, etc.). Query processor 215 may then send the query to the peers, receive and aggregate the responses, and display the received feedback to the user. Further details of an embodiment of the processing performed by query processor 215 are described in detail below in connection with FIG. 5.

In responding to queries from users of peer computing devices 260, query processor 215 may receive a completed response from responder 225, which may generate a response as described in detail below. Upon receipt of the response, query processor 215 may determine the location of the peer computing device to which the response should be sent by accessing social networking model 230. Finally, query processor 215 may transmit the completed response to the corresponding peer computing device 260 using a network interface.

Responder 225 may provide an interface that enables peer computing devices 260 to submit queries to framework 205 of computing device 200. In particular, responder 225 may receive incoming queries over a network interface, which may specify feedback requested by a peer computing device 260. Responder 225 may then query personal repository 235 for the corresponding data, while providing the identity of the peer, such that personal repository 235 may enforce any access permissions 240. Upon receipt of the requested data from personal repository 235, responder 225 may prepare and forward a response to query processor 215, which may then send the response to the appropriate peer as detailed above.

In addition to responding to queries, responder 225 may also maintain and comply with any subscription requests received from social repository 220 or included in incoming queries. In the first instance, responder 225 may receive a request from a user application 245, 250, 255 to automatically receive all feedback from a particular peer. Responder 225 may receive an identification of the peer from social repository 220, then forward a subscription request to query processor 215 for transmission to the appropriate peer.

Alternatively, responder 225 may receive a subscription query from a peer computing device 260, indicating that the peer wishes to automatically receive user feedback as it is collected from the user of computing device 200. Such a subscription query may, for example, identify a specific category of feedback or request a subscription to all feedback. Responder 225 may store any such subscriptions, identifying the requesting peer and the desired feedback. Responder 225 may then periodically query personal repository 235 for new information relevant to the subscriptions or, alternatively, receive all new feedback from personal repository 235 and determine its relevance. Upon receipt of new feedback of relevance to one or more subscribed peers, responder 225 may then prepare an appropriate response and forward it to query processor 215 for transmission to the appropriate peer computing device 260.

Upon receipt of a subscription response, peer computing device 260 may immediately notify the peer of the arrival of new feedback or, alternatively, wait to notify the peer. For example, in some embodiments, peer computing device 260 may wait to notify the peer until a context associated with the feedback is met. As one example, the user may be notified of the availability of new feedback based on a location of the peer (e.g., display an item of feedback when the user is near a restaurant to which the feedback relates).

In addition to the components for implementation of an API, framework 205 may also include a series of storage modules, each of which may be located in internal or external storage local to computing device 200 or in a remote location accessible to computing device 200 (e.g., a cloud server). The storage modules may include social repository 220, social network model 230, personal repository 235, and access permissions 240.

Social repository 220 may be used to store data pushed to computing device 200 by a peer computing device 260. For example, a user of computing device 200 may submit one or more subscription requests to automatically receive feedback from one or more peers. In addition to automatically sending the requested feedback, the peers may also send the content described by the feedback (e.g., video, audio, pictures, etc.) and, in response, computing device 200 may store this content in social repository 220. Such implementations are advantageous, as a user of computing device 200 may quickly access recommended content from social repository 220 without the need to download or otherwise obtain the content from another source.

Social networking model 230 may include information identifying peers with a relationship to the user of computing device 200. Model 230 may, for example, store a name or other identification of the peer and the nature of their relationship with the user. Alternatively, social networking model 230 may simply store an identification of the person (e.g., name, ID number, or user name) and assume that all peers have the same relationship with the user.

In addition, social networking model 230 may include information identifying a location of each peer with which communication is desired. Such information may include any data sufficient to transmit data to a location of a peer computing device 260, such as an IP address, MAC address, email address, telephone number, instant messaging handle or identification number, or the like.

Personal repository 235 may be configured similarly to personal repository 122 of FIG. 1. Thus, personal repository 235 may include feedback from a user of computing device 200 regarding a plurality of items. Specific examples of such feedback and corresponding items are provided above.

Access permissions 240, also described in further detail above in connection with personal repository 122, may specify feedback access levels for each peer identified in social networking model 230. Access permissions 240 may be specified by the user through interaction with an application accessible on computing device 200, such as OS 245, a local application 250, or a website 255. In some embodiments, writer 210 may include an additional API interface for receiving and storing these access permissions.

As detailed above, framework 205 may communicate with a number of applications 245, 250, 255. OS 245 may include built-in functionality to access framework 205, such that the user may provide and obtain feedback without the need for a separate application. Local applications 250 may include any application executing on computing device 200 and may include, for example, an email client, a web browser or plug-in, a media player, an instant messaging client, and the like. Finally, websites 255 may include any web-based applications, services, or pages that have the capability of communicating with framework 205.

As also detailed above, framework 205 may share feedback with a number of peer computing devices 260. Each peer computing device 260 may be configured similarly to computing device 200. Thus, as an example, each peer computing device 260 may also contain framework 205, such that the peers may store feedback and interact with other devices to send and receive feedback.

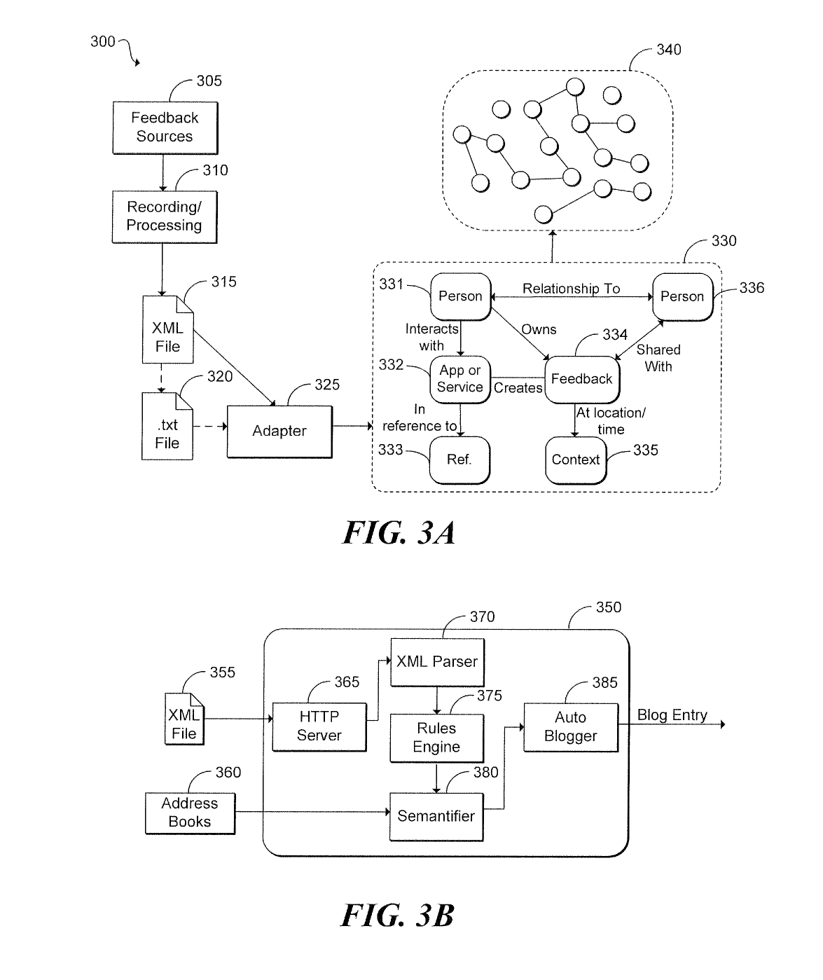

FIG. 3A is a block diagram of a series of modules 300 for translation of user feedback into a format suitable for inclusion in a graphical schema 340. Although the implementation of these modules is described in detail below with reference to computing device 200, other suitable devices for implementation of these modules 300 will be apparent to those of skill in the art. Each module 300 may comprise executable instructions and/or data storage implemented on a machine-readable storage medium, such as a storage medium included in computing device 200.

As illustrated, modules 300 may include a number of feedback sources 305. As detailed above in connection with FIG. 2, feedback may be provided by a number of applications, including an application or service running locally on computing device 200, an operating system of computing device 200, or by a website or web-based application. The feedback collected by feedback sources 305 may be obtained in response to explicit user entry (e.g., submission of a review or opinion) or may be obtained based on observation of the user's interaction with computing device 200 (e.g., click patterns, number of times a file is opened, duration of attention to a particular file, etc.). Regardless of the nature of the feedback, after feedback is received by a feedback source 305, it may be provided to module 310 for recording and processing.

Recording/processing module 310 may include a series of executable instructions for receiving feedback and parsing it into an appropriate format, such as Extensible Markup Language (XML). In particular, recording/processing module 310 may create an XML file including a number of tags corresponding to the fields contained in a given feedback item. For example, the tags for inclusion in such an XML file may include, for example, <person>, which may identify the user, <application>, which may identify the feedback source 305, <reference>, which may identify the subject of the feedback, <feedback>, which may contain the actual feedback data, and <context>, which may specify a date and time at which the feedback was received. XML file 315 may then be provided to adapter 325 for further processing.

In some embodiments, prior to providing the feedback data to adapter 325, XML file 315 may be translated to a text file 320. Such a translation process may include, for example, extracting only the information that will be maintained for the particular feedback item (e.g., user identification, feedback data, etc.). Such a process may be implemented using, for example, Extensible Stylesheet Language Transformations (XSLT). In such embodiments, each XSLT source file may comprise a number of tags that specify how to transform an XML feedback document into a text file containing the feedback data.

Adapter 325 may be configured to receive either an XML file 315 or a text file 320 and to translate the received data into a format suitable for inclusion in graphical schema 340. In particular, adapter 325 may comprise a series of executable instructions that translate the received file into schema format 330. Thus, adapter 325 may be configured to parse XML file 315 or text file 320 to identify each of the fields contained in the file, then to create a new object in schema format 330. Adapter 325 may then populate each field in the newly-created object with the appropriate information parsed from XML file 315 or text file 320.

As illustrated, schema format 330 may include a number of fields, each linked to one or more other fields with one or more corresponding edges, each edge representing a relationship between the fields. Person field 331 may contain data identifying the user (e.g., email address, instant messaging handle, etc.), while application field 332 may identify the application used to generate the feedback. Feedback field 334 may include the data generated by the user (e.g., opinion, rating, click data, etc.), while reference field 333 may identify the subject of the feedback (e.g., a movie, restaurant, hotel, PDF file, etc.). Context field 335 may identify information relevant to a time and/or location at which the feedback was generated (e.g., date and timestamp, physical location, etc.). Finally, person field 336 may identify one or more individuals in the user's social network that may potentially access feedback 334.

Thus, in the aggregate, the items in schema format 330 indicate that person 331 interacted with application 332 to create feedback 334 in reference to reference 333 at the location and time specified by context 335. Furthermore, person 331 owns feedback 334, which may be shared with one or more persons 336 with whom person 331 has a relationship.

After creation of a new object in schema format 330 representing the feedback of the user, adapter 325 may then insert the new object into graphical schema 340. In some embodiments, adapter 325 may link person field 331 of the new object to existing person fields contained in the graphical schema 340 based on the social networking links of person 331. In this manner, graphical schema 340 may include a number of people, each linked to person 331. Person 331, in turn, may be linked to each item of feedback contained in the user's personal repository.

After being populated with feedback data, graphical schema 340 may be queried using a proximity-based search. Thus, as an example, upon receipt of an incoming query, responder 225 of computing device 200 may be configured to query the graphical schema 340 in preparing a response for transmission to the peer. In particular, computing device 200 may receive a query from a peer computing device 260, which may be in a text format.

Upon receipt of the query, responder 225 may translate the query to a query of the format “Qualifier NEAR Predicate,” where a qualifier restricts the results to a node type of graphical schema 340 (e.g., person, application, feedback, etc.), while predicate is a Boolean expression that is applied to each node. In some embodiments, the predicate may be set based on the keywords included in the query. The value of the qualifier may be varied based on the type of search requested. Thus, as an example, the qualifier may be set to “Feedback” when the querying peer desires social recommendations about a product or item. As another example, the qualifier may be set to “Reference” to find recommendations relating to a particular item, while the qualifier may be set to “Application” to locate feedback generated using a particular application.

After setting the qualifier and predicate for the search, responder 225 may then execute the query using a proximity-based search. In particular, responder 225 may query graphical schema 340 to find nodes of the type specified by the qualifier with attributes matching those specified in the predicate. Upon encountering a node that matches the predicate, responder 225 may activate this node, such that energy is attributed to the node that decays as it travels through graphical schema 340. Responder 225 may use this technique to traverse graphical schema 340, resulting in a ranked list of candidate nodes based on the energy attributed to each. In some embodiments, such a proximity-based query algorithm may be implemented using a technique described in “SPIN: Searching Personal Information Networks,” by Soumen Chakrabarti et al and “Searching Personal Information Networks with SPIN” by Harsh Jain et al.

FIG. 3B is a block diagram of a series of modules for generating and posting a structured document containing user feedback. Although the implementation of these modules is described in detail below with reference to computing device 200, other suitable devices for implementation of these modules will be apparent to those of skill in the art. Each module may comprise executable instructions and/or data storage implemented on a machine-readable storage medium, such as a storage medium included in computing device 200.

Writer 350 of FIG. 3B may correspond to writer 210 of FIG. 2 and may therefore receive an item of feedback as input and, in response, write the feedback to an appropriate location. In particular, through execution of the modules described in detail below, writer 350 may be configured to automatically post a structured document to a location accessible on the World Wide Web, such as a web log (also known as a “blog”).

As illustrated Hypertext Transfer Protocol (HTTP) server 365 may receive an XML file 355 as input. In some embodiments, XML file 355 may be generated by recording/processing module 310 of FIG. 3A, then transmitted by adapter 325 to HTTP server 365. Upon receipt, HTTP server 365 may initiate an XML parser 370, which may be configured to parse the fields included in XML file 355 into a format readable by rules engine 375. In some embodiments, parser 370 may read the XML file and convert each field into a corresponding collection of Java objects. As a specific example, parser 370 may convert the <person> field to a corresponding Person object, which may include a String object corresponding to the name of the person.

XML parser 370 may then output the parsed data to rules engine 375, which may, in turn, generate a structured document containing the feedback of the user regarding the particular item. For example, rules engine 375 may be configured based on a set of user-generated rules that provide a textual mapping between a name of an incoming variable and an attribute of a predefined format. For example, the predefined format may specify a number of fields (e.g., person, application, feedback, etc.), and a formatting for the fields including placement, font sizes and colors, and the like. By mapping the incoming data (e.g., Java objects) to each field in the predetermined format, rules engine 375 may create an object mapping readable by semantifier 380.

Upon receipt of an object mapping from rules engine 375, semantifier 380 may create a structured document (e.g., HTML, XHTML) containing the specified fields. For example, in some embodiments, rules engine 375 may create an XHTML file by including microformat class tags along with a series of HTML tags. Alternatively, rules engine 375 may create a basic HTML file containing the feedback and other fields. Finally, semantifier 380 may submit the structured document to auto-blogger 385, which may automatically post the generated document to one or more locations accessible on the web. These locations may be specified by the user in, for example, an address book 360.

FIG. 4 is a flowchart of an example of a method 400 for storing feedback of a user regarding a particular item in a personal repository. Although execution of method 400 is described below with reference to the components of computing device 200, other suitable components for execution of method 400 will be apparent to those of skill in the art. Method 400 may be implemented in the form of executable instructions stored on a machine-readable storage medium, such as a storage medium included in computing device 200.

Method 400 may start in block 405 and proceed to block 410, where computing device 200 may receive a request to write feedback of a user to a personal repository 235. The feedback provided by the user may be any text, audio, or other user input that indicates a user's disposition toward a particular item. In some embodiments, the request to write feedback may be initiated by an application 245, 250, 255 with which the user has interacted. For example, the request may be generated by a web browser, media player, or other application immediately upon submission of user feedback regarding an item. Alternatively, the request may be generated by a user through the use of an application designed to directly write feedback to personal repository 235.

Upon receipt of a write request, method 400 may proceed to block 420, where computing device 200 may determine whether personal repository 235 is local to computing device 200 or, alternatively, located in a cloud server. Computing device 200 may make this determination by, for example, accessing configuration settings that identify a predetermined or user-specified location for personal repository 235.

When it is determined in block 420 that personal repository 235 is maintained in a local repository, computing device 200 may write the feedback to repository 235 via a local bus (e.g., Universal Serial Bus, Firewire interface, Advanced Technology Attachment (ATA), etc.). In some embodiments, writing of the feedback may be established through interaction with an API exposed by framework 205 and, more specifically, writer 210. Method 400 may then proceed to block 460.

Alternatively, when it is determined in block 420 that personal repository 235 is located “in the cloud” (i.e., on a remote server), method 400 may proceed to block 440. In block 440, computing device 200 may first establish a connection with personal repository 235 by, for example, determining a location of the server, establishing a communication session with the server, and authenticating the user. Upon successful establishment of a connection, method 400 may proceed to block 450, where computing device 400 may write the feedback to repository 235. Again, in some embodiments, writer 210 of framework 205 may handle the process for writing the feedback. Method 400 may then proceed to block 460.

In block 460, computing device 200 may establish access permissions for the feedback written to repository 235. In some embodiments, the user may specify these permissions by sending a configuration command to access permissions 240 independently of write requests. For example, the user may identify at least a portion of the feedback and at least a portion of peers to whom access permission is granted or denied. Alternatively, a level of access for groups of peers may be included with the write request, such that writer 210 of framework 205 may update access permissions 240.

Method 400 may then proceed to block 470, where computing device 200 may determine whether any peers have subscriptions that include the feedback received in block 410. In some embodiments, personal repository 235 may make this determination immediately upon receipt of the feedback. Alternatively, another module in framework 205, such as responder 225, may periodically access the subscriptions and feedback in repository 235 to identify any peer subscriptions for which new feedback is available.

Regardless of the implementation, when it is determined in block 480 that one or more peers have subscriptions that include the feedback, method 400 may proceed to block 480, where computing device 200 may send the feedback to the subscribed peers. In some embodiments, responder 225 may prepare a response including the feedback and forward the feedback to query processor 215. In response, query processor 215 may determine the location of each peer by accessing social networking model 230, then forward the feedback to the one or more peers. After sending any subscribed feedback or after determining that there are no relevant subscriptions, method 400 may proceed to block 485, where method 400 may stop.

FIG. 5 is a flowchart of an example of a method 500 for requesting and receiving feedback from social networking peers 260 of a user of a personal computing device 200. Although execution of method 500 is described below with reference to the components of computing device 200, other suitable components for execution of method 500 will be apparent to those of skill in the art. Method 500 may be implemented in the form of executable instructions stored on a machine-readable storage medium, such as a medium included in computing device 200.

Method 500 may start in block 505 and proceed to block 510, where computing device 200 may receive a feedback query identifying a group of one or more peers and a search parameter. As one example, the user may specify the peers in the group by selecting or otherwise specifying one or more individuals identified in social networking model 230 or by simply indicating that all peers should be included. As another example, the user may specify the peers based on a relationship to the user (e.g., friends, best friends, family members, colleagues, etc.). In such embodiments, computing device may access social networking model 230 to determine all members with the specified relationship to the user.

The user may specify the search parameter by, for example, entering a search string or selecting a category or type of feedback to be retrieved. Thus, the search parameter may relate to multiple items or instead, may specifically identify a single item for which the user desires feedback. In some embodiments, query processor 215 of framework 205 may receive the query from an application 245, 250, 255 of computing device 200.

Method 500 may then proceed to block 520, where computing device 200 may determine the location to which queries are directed for each of the one or more peers. As one example, query processor 215 may access social networking model 230 to determine an IP address, email address, instant messaging handle, or similar information sufficient to transmit the query to a location of the peer computing device 260 corresponding to each peer. Thus, query processor 215 may submit a name or other identifier of each peer to social networking model 230 and, in response, receive a location for each peer computing device 260.

Method 500 may then proceed to block 530, where computing device 200 may send the feedback query to each location determined in block 520. In particular, query processor 215 or some other component of computing device 200 may transmit the query to each peer using a network interface and one or more network protocols. For example, when the determined location is an IP address of the peer computing device 260, computing device 200 may send the query using IP. Similarly, computing device 200 may compose and send an email or instant message including the query. Other suitable methods for sending a query request will be apparent to those of skill in the art depending on the identified location of each peer computing device 260.

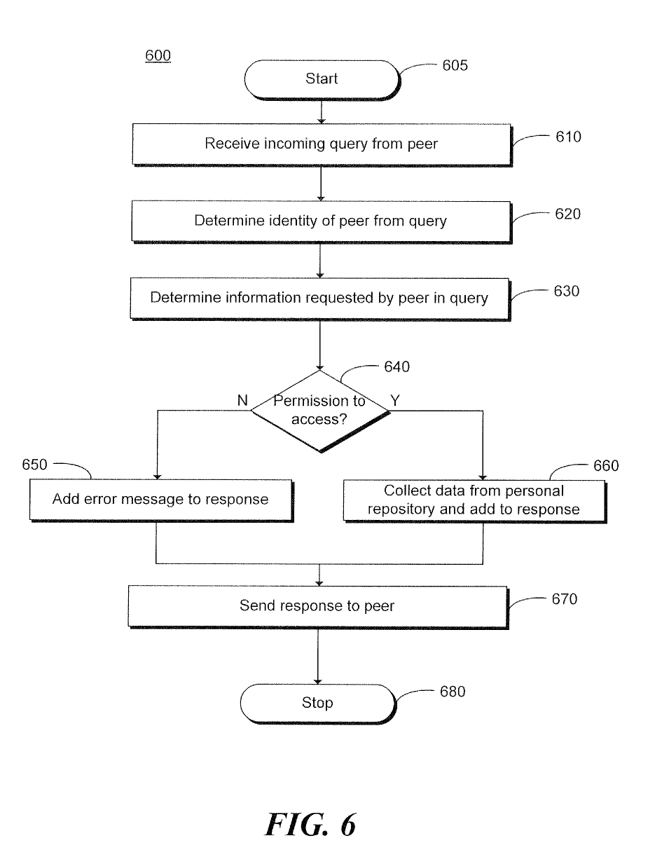

After sending each query in block 530, method 500 may proceed to block 540, where computing device 200 may receive a response from each peer computing device 260. Each peer computing device 260 may generate the response by accessing a personal repository using the search parameter. Further details regarding an example process performed by each peer computing device 260 in responding to the query are provided below in connection with FIG. 6.

After receipt of each response, method 500 may proceed to block 550, where computing device 200 may aggregate and display the responses to the user of computing device 200. For example, when the user has requested feedback regarding a single item, computing device 200 may display all received feedback in a list, table, or similar format. In some embodiments, computing device 200 may determine an average rating, identify terms most frequently used in each item of feedback, or otherwise summarize the information prior to display to the user. When the user has requested feedback regarding multiple items, computing device 200 may divide the feedback into sections, then display each section as described above. Other suitable methods of aggregation and display formats will be apparent to those of skill in the art. Finally, after output of the query responses, method 500 may proceed to block 555, where method 500 may stop.

FIG. 6 is a flowchart of an example of a method 600 for responding to an incoming query from a personal computing device 200 controlled by a peer of a user. Although execution of method 600 is described below with reference to the components of computing device 200, other suitable components for execution of method 600 will be apparent to those of skill in the art. Method 600 may be implemented in the form of executable instructions stored on a machine-readable storage medium, such as a storage medium included in computing device 200.

Method 600 may start in block 605 and proceed to block 610, where computing device 200 may receive an incoming query from a peer computing device 260. The incoming query may be in a number of forms, including, for example, an email message, an instant message, or a message readable in accordance with an API provided by framework 205 of computing device 200. In some embodiments, responder 225 may receive the incoming query through a network interface of computing device 200.

After receipt of the incoming query from a peer, method 600 may proceed to block 620, where computing device 200 may determine the identity of the peer corresponding to the transmitting peer computing device 260 using, for example, responder 225. For example, computing device 200 may extract the identity of the peer directly from the query by parsing the query in accordance with an expected message format. As another example, computing device 200 may determine the source of the query (e.g., email address, IM handle, IP address, etc.), then access social network model 230 or a similar module to ascertain the identity of the peer using the determined source.

Method 600 may then proceed to block 630, where computing device 200 may determine the information requested in the query by the peer computing device 260 using, for example, responder 225. In particular, the query may identify requested feedback using, for example, a search string, a category of feedback, a specific item, or any other description of the desired feedback. As one example, computing device 200 may determine the requested information by parsing or otherwise extracting the description of the desired feedback from the query. For example, when the query is received as an email, computing device 200 may determine the requested feedback by parsing the subject line, message body, or a combination thereof. Similarly, when the query is received as an instant message, computing device 200 may determine the requested feedback by parsing the message body.

After determination of the peer's identity and the requested feedback, method 600 may proceed to block 640, where computing device 200 may determine whether the identified peer has permission to access the requested feedback using, for example, responder 225. In making this determination, computing device 200 may access personal repository 235 with an identification of the requested feedback and the requesting peer. Personal repository 235 may, in turn, determine whether the requesting peer has permission to access the requested feedback using access permissions 240. As detailed above, this determination may be based on, for example, a nature of the relationship of the user of computing device 200 with the peer (e.g., friend, family, colleague, etc.), the type of feedback requested (e.g., star ratings, click data, etc.), and/or the items to which the feedback relates (e.g., movies, hotels, doctors, etc.).

When it is determined in block 640 that the peer does not have permission to access the requested feedback, method 600 may proceed to block 650, where computing device 200 may add an error message to the response to be sent to the peer computing device 260. For example, responder 225 may add a message to the response that identifies the requested feedback and indicates that the peer does not have access permission to that feedback. In some embodiments, rather than adding an error message to the response, computing device 200 may simply omit the information for which access is denied. The format of the response to be sent to the peer computing device 260 may be the same as the format of the query received in block 610 (e.g., email, IM, predefined message format, etc.).

Alternatively, when it is determined in block 640 that the peer has permission to access the requested feedback, method 600 may proceed to block 660, where computing device 200 may retrieve the feedback data from personal repository 235 and add it to a response using, for example, responder 225. In particular, computing device 200 may query personal repository 235 by specifying a type of feedback and/or items for which feedback of the user is desired. In response, personal repository 235 may return any feedback data and computing device 200 may insert this data into the response, Again, the response may be in a number of formats (e.g., email, IM, predefined message format, etc.).

Although blocks 650 and 660 are illustrated as two mutually exclusive blocks, it should be noted that, in some embodiments, computing device 200 may add an error message for the feedback for which access is denied, while inserting the feedback data for feedback for which permission is granted. For example, if a peer submits a request for all feedback maintained in personal repository 235, computing device 200 may include the information that the peer is allowed to access, while inserting an error message identifying or omitting any feedback for which access permission is denied.

After preparing the response in block 650 or in block 660, method 600 may proceed to block 670. In block 670, computing device 200 may transmit the prepared response to the peer computing device 260 corresponding to the requesting peer. In some embodiments, the response may be transmitted by query processor 215 after determining a location to which responses should be directed for peer computing device 260. After transmission of the response, method 600 may proceed to block 680, where method 600 may stop.

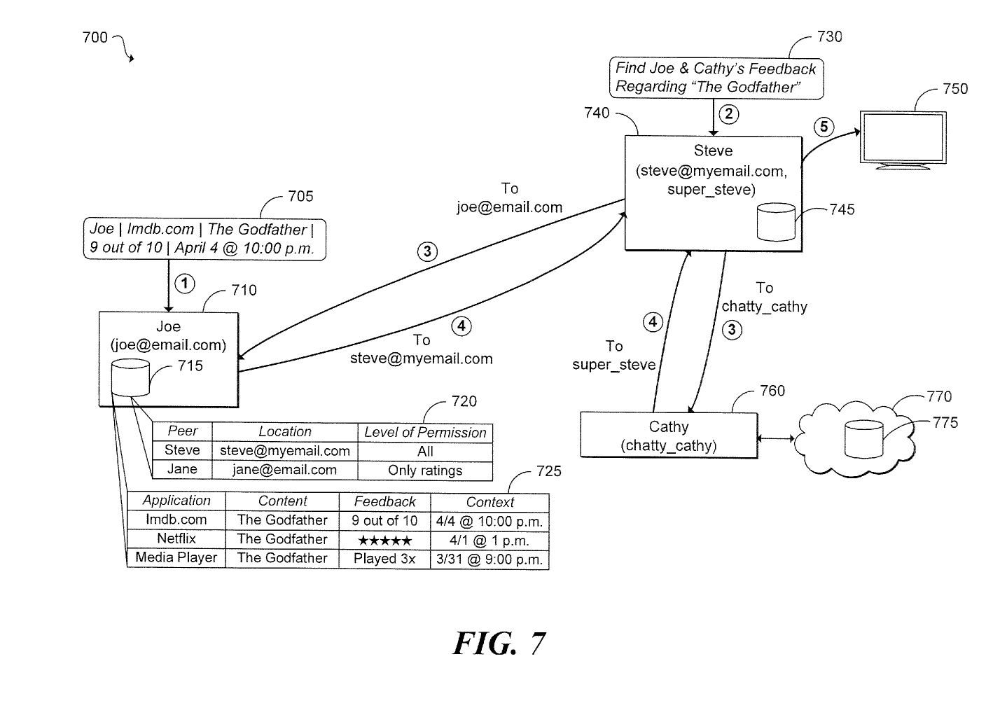

FIG. 7 is a schematic diagram of an example operation flow 700 illustrating storage of feedback, sending a query for feedback, and responding to such a query. As illustrated, FIG. 7 includes three computing devices, a first computing device 710 corresponding to a first user, Joe, a second computing device 740 corresponding to a second user, Steve, and a third computing device 760 corresponding to a third user, Cathy.

Each computing device 710, 740, 760 may have access to a personal repository 715, 745, 775, each repository maintaining data for the user of the corresponding computing device. Thus, as illustrated, computing device 710 may have access to a local personal repository 715, which may maintain feedback data for Joe. Personal repository 715 may include access permissions 720 and feedback data 725. Similarly, computing device 740 may have access to a local personal repository 745, which may maintain feedback for Steve. Finally, computing device 760 may have access to a cloud personal repository 775 in network 770, which may maintain feedback for Cathy.

As illustrated, in block 1 of operation flow 700, Joe may enter feedback 705 regarding a particular item. In this example, the feedback 705 is a movie review of the movie, “The Godfather.” As illustrated, Joe enters a rating of 9/10 into Imdb.com on April 4 at 10:00 p.m. Thus, in block 1 of operation flow 700, the application that receives the feedback may initiate a request to write the feedback into Joe's personal repository 715. For example, this request may be initiated by a web browser used to access Imdb.com or by a web-browser plug-in. In response, computing device 710 may access personal repository 715 and write the new feedback into feedback data 725. Thus, as illustrated, the most recent item in feedback data 725 may be Joe's review of “The Godfather,” as submitted to Imdb.com.

In block 2 of operation flow 700, Steve may decide that he is interested in receiving feedback from two individuals in his social network regarding “The Godfather.” In particular, Steve may indicate, through entry of a query 730, that he wishes to receive all feedback regarding “The Godfather” from both Joe and Cathy. Accordingly, upon receipt of such a request, computing device 740 may determine a location to which feedback requests should be submitted for Joe and Cathy. Here, computing device 740 may determine that requests for Joe should be emailed to “joe@email.com,” while requests for Cathy should be sent via instant messaging to “chatty_cathy.” Accordingly, in block 3, computing device 740 may send the appropriate queries to Joe's computing device 710 and to Cathy's computing device 760.

In block 4 of operation flow 700, the computing devices 710, 760 corresponding to Joe and Cathy, respectively, may receive the queries and respond accordingly. Thus, computing device 710 may first determine access permissions granted by Joe to Steve. Here, access permissions 720 specify that Steve has permission to access all of Joe's feedback. Accordingly, computing device 710 may compile the data included in feedback data 725 corresponding to “The Godfather,” then send a response including the feedback to Steve's email address, steve@myemail.com. Computing device 760 corresponding to Cathy may prepare the response in a similar manner, but may instead query cloud repository 775 in network 770 for any of Cathy's feedback relating to “The Godfather.” Computing device 760 may then return the response including any such feedback to Steve's IM handle, “super_steve.”

In block 5 of operation flow 700, computing device 740 may receive all feedback transmitted by Joe's computing device 710 and Cathy's computing device 760. Accordingly, computing device 740 may aggregate the feedback and display it to Steve via output device 750, which may be, for example, a liquid crystal display (LCD), Cathode Ray Tube (CRT) monitor, or any similar display device.

According to the foregoing, various example embodiments relate to a framework that allows users of computing devices to maintain feedback in a personal repository and to share that feedback with users in their social network. Such embodiments are advantageous, as they allow a user to target feedback queries to specific individuals based on, for example, a level of trust or a perceived expertise of peers in the user's social network. Furthermore, the user may control access to the feedback stored in the personal repository by setting access permissions for his or her peers. In this manner, although a large amount of feedback is aggregated in a single location, the user may maintain control over which feedback is made available to particular peers, thereby maintaining the user's security and privacy.

We claim:

1. A machine-readable storage medium encoded with instructions executable by a processor of a personal computing device, the machine-readable storage medium comprising:
instructions for receiving a request for writing feedback of a user of the personal computing device regarding a particular item to a personal repository accessible to the personal computing device;
instructions for storing the feedback of the user regarding the particular item in the personal repository; and
instructions for sending a response to an incoming query from a personal computing device controlled by a peer of the user regarding the feedback of the user stored in the personal repository, wherein feedback contained in the response is constrained by repository access permissions specified for the peer by the user of the personal computing device.

2. The machine-readable storage medium of claim 1, wherein the instructions for receiving the request for writing the feedback provide an Application Programming Interface (API) accessible to local applications and services running on the personal computing device, the API allowing the applications and services to specify the feedback to be stored in the personal repository.

3. The machine-readable storage medium of claim 2, wherein the request for writing the feedback regarding the particular item is provided by calling the API from at least one of an operating system (OS), a web browser, a web browser plug-in, a web-based application, and a media player.

4. The machine-readable storage medium of claim 1, wherein the instructions for storing the feedback of the user store a duplicate of the feedback provided by the user to an application or service running on the computing device.

5. The machine-readable storage medium of claim 1, wherein the instructions for storing the feedback of the user in the personal repository store a Uniform Resource Locator (URL) identifying a location from which the feedback may be retrieved.

6. The machine-readable storage medium of claim 1, wherein the instructions for storing the feedback of the user further comprise;
instructions for translating the feedback of the user regarding the particular item into a format suitable for inclusion in a graphical schema; and
instructions for adding the translated feedback into the graphical schema.

7. The machine-readable storage medium of claim 1, wherein the instructions for storing the feedback of the user further comprise:
instructions for generating a structured document containing the feedback of the user regarding the particular item; and
instructions for automatically posting the generated structured document to a location accessible on the World Wide Web.

8. The machine-readable storage medium of claim 1, wherein the repository access permissions comprise identifications of particular categories of feedback and corresponding peers who are allowed to access the feedback contained in each category.

9. A personal computing device comprising:
a processor; and
a machine-readable storage medium encoded with instructions executable by the processor, the machine-readable storage medium comprising:
instructions for accessing a personal repository for which access permissions are controlled by a user of the personal computing device,
instructions for storing, in the personal repository, user feedback provided by the user regarding a particular item,
instructions for storing social networking information in the personal repository, the social networking information identifying peers of the user of the personal computing device, and
instructions for sending a response to a query from a particular peer of the user regarding the feedback of the user for the particular item, wherein information included in the response is based on access permission granted by the user to the particular peer to access the user feedback.

10. The personal computing device of claim 9, wherein the machine-readable storage medium further comprises:
instructions for automatically sending the user feedback upon receipt of the feedback to a set of subscribed peers identified in the social networking information.

11. The personal computing device of claim 10, wherein the instructions for automatically sending the user feedback further comprise:
instructions for automatically sending a content item described by the user feedback for storage by the set of subscribed peers.

12. The personal computing device of claim 9, wherein the instructions for sending the response to the query comprise:
instructions for receiving an email message from the particular peer, the email message including the query;
instructions for accessing the personal repository to retrieve user feedback relevant to the query; and
instructions for sending an email reply including results of the query.

13. The personal computing device of claim 9, wherein the instructions for storing the user feedback further comprise:
instructions for translating the feedback regarding the particular item into a format suitable for inclusion in a graphical schema; and
instructions for adding the translated feedback into the graphical schema.

14. The personal computing device of claim 13, wherein the format suitable for inclusion in the graphical schema includes an identification of the user, an application or service through which the feedback was created, an identification of the particular item, and an identification of a context of the feedback.

15. A method for receiving, in a personal computing device, feedback from social networking peers of a user of the personal computing device, the method comprising:
receiving, by the personal computing device, a feedback query identifying a group of peers and a search parameter;
determining a location to which queries are directed for a peer personal computing device corresponding to each peer in the group of peers using social networking information accessible to the personal computing device;
sending the feedback query to the determined location for each peer personal computing device corresponding to each peer; and
receiving a response to the feedback query from each peer personal computing device, wherein each peer personal computing device generates the response by accessing a corresponding personal repository using the search parameter.

16. The method of claim 15, wherein the search parameter identifies a particular item for which the user desires feedback from the group of peers.

17. The method of claim 16, wherein the feedback regarding the particular item includes at least one of a rating, a review, an opinion, a frequency of access, and a duration of access.

18. The method of claim 15, wherein:
the feedback query identifies the group of peers using a specified relationship to the user of the personal computing device, and
members of the group of peers are determined by querying the social networking information using the specified relationship.

19. The method of claim 15, wherein the determined location is at least one of:
an instant messaging address accessible to an instant messaging client running on the peer personal computing device, and
an email address accessible to an email client running on the peer personal computing device.

20. The method of claim 15, wherein the personal repository controlled by each peer is located on a storage medium of the peer personal computing device or on a cloud storage location accessible to the peer personal computing device.
